(19) United States
(12) Patent Application Publication
(10) Pub. No.: US 2024/0188062 A1
(43) Pub. Date: Jun. 6, 2024

(54) METHOD AND APPARATUS FOR BEAM RECOVERY IN WIRELESS COMMUNICATION SYSTEM

(71) Applicant: Electronics and Telecommunications Research Institute, Daejeon (KR)

(72) Inventors: Jung Im KIM, Daejeon (KR); Young Jo KO, Daejeon (KR); II Gyu KIM, Daejeon (KR); Sung Cheol CHANG, Daejeon (KR); Hee Sang CHUNG, Daejeon (KR); Yong Seouk CHOI, Daejeon (KR)

(73) Assignee: Electronics and Telecommunications Research Institute, Daejeon (KR)

(21) Appl. No.: 18/524,522

(22) Filed: Nov. 30, 2023

(30) Foreign Application Priority Data
Dec. 1, 2022 (KR) 10-2022-0165471

(51) Int. Cl. H04W 72/044; H04L 5/00; H04W 76/19

(52) U.S. Cl. CPC H04W 72/046; H04L 5/0048; H04W 76/19

(57) ABSTRACT

A method of user equipment may comprise: determining whether an error condition for a first beam communicating with a base station is met; when it is determined that the error condition for the first beam is met, determining whether a first physical uplink control channel (PUCCH) allocated to the user equipment is present within a predetermined first period of time; when it is determined that the first PUCCH is not present, transmitting a sounding reference signal (SRS) transmission approval request and an identifier of the user equipment to the base station through a second PUCCH pre-configured to be shared by all pieces of user equipment; and when an SRS transmission approval is received from the base station, transmitting an SRS to the base station.

### CROSS-REFERENCE TO RELATED APPLICATIONS

This application claims priority to Korean Patent Application No. 10-2022-0165471, filed on Dec. 1, 2022, with the Korean Intellectual Property Office (KIPO), the entire contents of which are hereby incorporated by reference.

### BACKGROUND

### 1. Technical Field

Example embodiments of the present disclosure relate to beam recovery technology, and more specifically, to beam recovery technology in high-frequency communication.

### 2. Related Art

Mobile communication systems use multiple antennas to take advantage of radio channel characteristics. In particular, in high-frequency communication such as millimeter waves (mmWave), propagation loss increases and the communication range decreases, and thus transmission power is concentrated in a specific direction (beamforming) or a beam may be formed and transmitted to be focused on a specific location in space.

In high-frequency communication such as mmWave and sub-terahertz (THz), a wavelength becomes shorter, and thus a physical size of a reception antenna also decreases. Accordingly, energy received by an antenna decreases. For example, when a frequency increases by 10 times, a wavelength decreases by 10 times, and physically, received energy in an antenna domain decreases by 100 times. In order to avoid such energy reduction, transmission and reception are performed by performing beamforming using the directivity of the antenna.

The 3^{rd} Generation Partnership Project fifth-generation new radio (3GPP 5G NR) frequency region 2 (FR2) carrier frequency ranges from 24.25 to 52.6 GHz, and antenna processing is performed in an analog domain focusing on beamforming. In the case of analog-based receive beamforming, a received beam may only be focused in one direction at one time. A transceiver commonly sets and maintains a transmitter-side beam direction and a receiver-side beam direction.

In the 3GPP 5G NR high-frequency range, in order to select and use a beam direction that is advantageous to user equipment (UE), the UE may measure a reference signal (RS) transmitted by a base station, and report a direction that is advantageous to the UE to the base station when the UE accesses to a network. The base station obtains information on the beam direction that is advantageous to the UE, and then causes the UE to transmit uplink control information (UCI) to the base station through the uplink in order to allocate radio resources according to specific channel conditions for the wireless beam direction of the UE.

The UCI includes radio channel status information (CSI) measured by the UE, CRC error reporting (HARQ-feedback) of data received by the UE, and radio resource scheduling request (SR) so that the UE can transmit data to the base station. The uplink control information is transmitted through a physical uplink control channel (PUCCH).

The CSI, which is radio channel status information reported by the UE to the base station, includes a CSI-RS resource indicator (CRI), a transmission rank indicator (RI) of the radio channel measured by the UE, a precoding-matrix indicator (PMI) suitable for a given RI, and a channel quality indicator (CQI) indicating adaptive modulation coding (AMC) suitable for the UE in a given precoding-matrix indicator. The UE may transmit one or several CSI components simultaneously through the PUCCH. Conventional UCI does not contain information for initiating a beam recovery error procedure.

In this case, when a beam error occurs, it may take a significant amount of time to overcome a beam error/failure.

### SUMMARY

Example embodiments of the present disclosure provide a method and apparatus for rapidly overcoming a beam error/failure between user equipment and a base station in high-frequency communication such as millimeter waves (mmWave) and terahertz (THz).

According to a first exemplary embodiment of the present disclosure, a method of user equipment may comprise: determining whether an error condition for a first beam communicating with a base station is met; when it is determined that the error condition for the first beam is met, determining whether a first physical uplink control channel (PUCCH) allocated to the user equipment is present within a predetermined first period of time; when it is determined that the first PUCCH is not present, transmitting a sounding reference signal (SRS) transmission approval request and an identifier of the user equipment to the base station through a second PUCCH preset to be shared by all pieces of user equipment; and when an SRS transmission approval is received from the base station, transmitting an SRS to the base station.

The method may further comprise: after the SRS is transmitted to the base station, receiving a beamformed reference signal (RS) from the base station; and transmitting a channel status report to the base station by measuring the received RS.

A case in which the error condition for the first beam is met may be: a case in which an average value of reference signals received power (RSRP) for the RS received from the base station through the first beam is less than or equal to a pre-configured threshold value; or a case in which a consecutive decoding error of data received from the base station through the first beam is more than or equal to a preset number of times.

The second PUCCH may be pre-configured by higher layer signaling or a system information block (SIB).

The method may further comprise: when it is determined that the first PUCCH allocated to the user equipment is present within the first period of time, transmitting the SRS transmission approval request to the base station through the first PUCCH; and when the SRS transmission approval is received from the base station, transmitting the SRS to the base station.

The method may further comprise: when the SRS transmission approval is not received from the base station within a predetermined second period of time after transmitting the SRS transmission approval request to the base station, determining whether a third PUCCH allocated to the user equipment is present within the first period of time; and when it is determined that the third PUCCH is present, re-transmitting the SRS transmission approval request to the base station through the third PUCCH.

The method may further comprise, when the SRS transmission approval is not received within the second period of time after transmitting the SRS transmission approval request to the base station, and when the third PUCCH is not present within the first period of time, re-transmitting the SRS transmission approval request to the base station through the second PUCCH.

According to other exemplary embodiment of the present disclosure, a method of user equipment may comprise: determining whether an error condition for a first beam communicating with a base station is met; when it is determined that the error condition for the first beam is met, selecting a reference signal (RS) with a largest reference signals received power (RSRP) value from among RSs received through beams other than the first beam; determining whether a first physical uplink control channel (PUCCH) allocated to the user equipment is present within a predetermined first period of time; when it is determined that the first PUCCH is not present, transmitting a channel status report approval request and an identifier of the user equipment to the base station through a preset second PUCCH to be shared by all pieces of user equipment; and when a channel status report approval is received from the base station, transmitting a channel status report for the beam on which the RS with the largest RSRP value is transmitted to the base station.

A case in which the error condition for the first beam is met may be: a case in which an average value of the RSRP for the RS received from the base station through the first beam is less than or equal to a (pre)configured threshold value; or a case in which a consecutive decoding error of data received from the base station through the first beam is more than or equal to a preset number of times.

The second PUCCH may be preset by higher layer signaling or a system information block (SIB).

The method may further comprise: when it is determined that the first PUCCH allocated to the user equipment is present within the first period of time, transmitting the channel status report approval request to the base station through the first PUCCH; and when the channel status report approval is received from the base station, transmitting the channel status report to the base station.

The method may further comprise: when the channel status report approval is not received from the base station within a predetermined second period of time after transmitting the channel status report approval request to the base station, determining whether a third PUCCH allocated to the user equipment is present within the first period of time; and when it is determined that the third PUCCH is present, re-transmitting the channel status report approval request to the base station through the third PUCCH.

The method may further comprise, when the channel status report approval is not received within the second period of time after transmitting the channel status report approval request to the base station, and when the third PUCCH is not present within the first period of time, re-transmitting the channel status report approval request to the base station through the second PUCCH.

According to another exemplary embodiment of the present disclosure, a method of a base station may comprise: transmitting information on a preset second physical uplink control channel (PUCCH) to user equipment to be shared by all pieces of user equipment in the base station; determining a first beam to be used for communication with the user equipment through a random access procedure; communicating with the user equipment through the first beam; receiving a sounding reference signal (SRS) transmission approval request for beam recovery from the user equipment through the second PUCCH; and transmitting an SRS transmission approval to the user equipment in response to the SRS transmission approval request.

The method may further comprise: receiving an SRS from the user equipment; measuring the received SRS and calculating a beamforming weight of a reference signal (RS) to be transmitted to the user equipment; transmitting a beamformed reference signal to the user equipment using the beamforming weight; and receiving a channel status report from the user equipment.

The information on the second PUCCH may be transmitted to the user equipment through higher layer signaling or a system information block (SIB).

The method may further comprise transmitting condition information including a first period of time for using the second PUCCH to the user equipment through higher layer signaling, wherein the condition information instructs the user equipment to use the second PUCCH when a first PUCCH allocated to the user equipment is not present within the first period of time, when the error condition is met.

A case in which the error condition is met may be: a case in which an average value of reference signals received power (RSRP) for the RS received from the base station through the first beam is less than or equal to a (pre)configured threshold value; or a case in which a consecutive decoding error of data received from the base station through the first beam is more than or equal to a preset number of times.

The method may further comprise: when the SRS transmission approval request for the beam recovery is received through the first PUCCH allocated to the user equipment during the communication, transmitting an SRS transmission approval including SRS transmission resource allocation information to the user equipment; receiving the SRS from the user equipment; measuring the received SRS and calculating a beamforming weight of a RS to be transmitted to the user equipment; transmitting a beam formed reference signal to the user equipment using the beamforming weight; and receiving a channel status report from the user equipment.

According to embodiments of the present disclosure, user equipment dynamically requests SRS transmission approval and an opportunity to report CSI and a base station rapidly obtains radio CSI of the user equipment so that a beam error recovery procedure can be initiated using physical uplink control information, and thus beam recovery can be performed rapidly. Further, according to the present disclosure, a procedure of starting to overcome a beam error using a PUCCH shared by a plurality of pieces of user equipment can rapidly overcome the beam error even within a limitation of a size of the PUCCH.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a flowchart of a case in which recovery is performed when a beam error occurs during communication after initial beam setting.

FIG. 4 is a flowchart of a case in which recovery is performed when a beam error occurs during communication after beam setting on the basis of a sounding reference signal.

FIG. 5A is a partial flowchart for describing a first embodiment of initiating a beam management procedure based on an average RSRP measurement value of a reference signal.

FIG. 5B is a remaining flowchart for describing the first embodiment of initiating the beam management procedure based on the average RSRP measurement value of the reference signal.

FIG. 6A is a partial flowchart for describing a second embodiment of initiating a beam management procedure based on an average RSRP measurement value of a reference signal.

FIG. 6B is a remaining flowchart for describing the second embodiment of initiating the beam management procedure based on the average RSRP measurement value of the reference signal.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

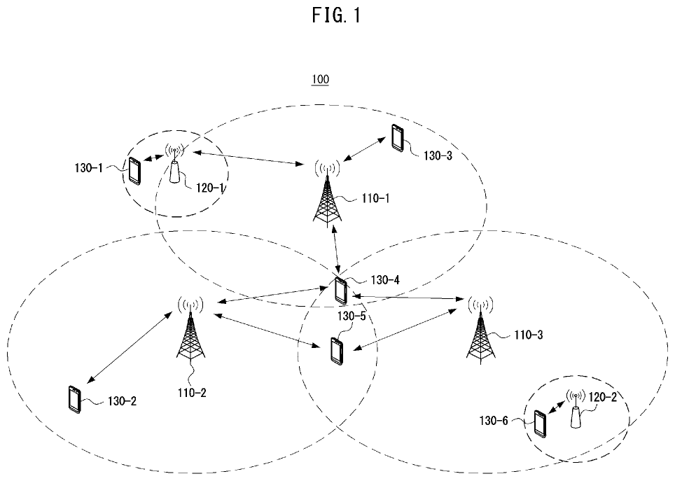

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g. long term evolution (LTE), LTE-advanced (LTE-A)), 5th generation (5G) communication (e.g. new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

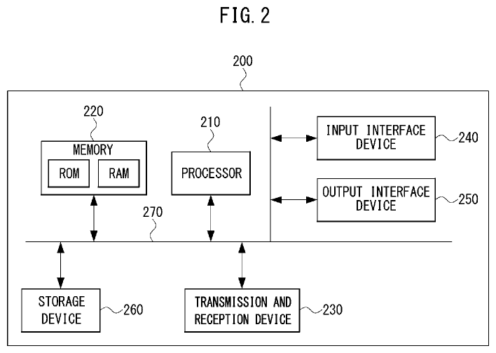

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IOT) device, a mounted apparatus (e.g. a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, in beam management in the 3^{rd} Generation Partnership Project fifth-generation new radio frequency region 2 (3GPP 5G NR FR2), initial beam setting, beam adjustment due to the movement of the user equipment and gradual changes in the surrounding environment, and beam recovery due to rapid environmental changes such as obstacles between the base station and the user equipment, may be performed. Hereinafter, a recovery method in case a beam error occurs during communication after initial beam setting will be described with reference to the accompanying drawings.

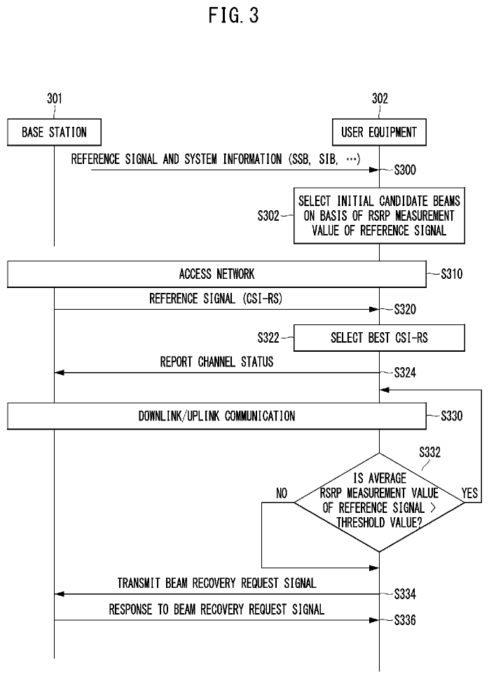

FIG. 3 is a flowchart of a case in which recovery is performed when a beam error occurs during communication after configuring initial beam.

In FIG. 3, a base station 301 and user equipment 302 are illustrated as components of a network. Each of the base station 301 and the user equipment 302 may include all or part of the components of the communication node 200 as illustrated in FIG. 2 above. Further, the base station 301 may further include a component for connecting to a higher level node not illustrated in FIG. 2, such as a node of a core network, a component for connecting between base stations, and the like. Further, the user equipment 302 may further include a component for a user interface, various types of sensors, and the like.

Referring to FIG. 3, the base station 301 may periodically broadcast a synchronization signal block (SSB) and a system information block (SIB) within its cell in operation S300. When the base station 301 broadcasts SSBs within its cell using a plurality of beams, the base station 301 may transmit a plurality of SSBs sequentially in a downlink beam direction. Therefore, the user equipment 302 may obtain the SSB and the SIB during an initial cell search in operation S300.

In operation S302, the user equipment 302 may measure reference signals received power (RSRP) for the reference signal included in the SSB. In addition, initial candidate beams may be selected based on the measured RSRP. In other words, a downlink beam of the base station 301 and a random access (RA) preamble that is transmitted by the user equipment 302 to access the network are related. Therefore, the user equipment 302 may perform the initial beam setting using the related information.

In operation S310, the user equipment 302 may perform network access using the beam with the best RSRP for the reference signal included in the SSB. In the present disclosure, the network access may include a procedure for transmitting an RA preamble containing initial candidate beam index set information to a RA channel (RACH). In operation S310, the base station 301 may transmit an RA response (RAR) in response to one index of candidate beam indices included in the RA preamble from the RACH transmitted by the user equipment 302. In other words, operation S310 may correspond to a RACH procedure.

In operation S320, the base station 301 may transmit the reference signal, for example, the CSI-RS, to the user equipment 302. In this case, the base station 301 may transmit the CSI-RS for each beam. Therefore, in operation S320, the user equipment 302 may receive the CSI-RS for each beam and measure the RSRP for each received CSI-RS.

In operation S322, the user equipment 302 may select the best CSI-RS on the basis of the measured RSRP for the CSI-RS. In other words, the user equipment 302 may select the beam with the largest RSRP value.

In operation S324, the user equipment 302 may report channel status information (CSI) through a PUCCH on the basis of the selected beam. Accordingly, the base station 301 may identify the beam selected by the user equipment 302 through the CSI reported by the user equipment 302. As described above, the CSI may include at least one of a CSI-RS resource indicator (CRI), a precoding-matrix indicator (PMI), rank indicator (RI), and a channel quality indicator (CQI).

In operation S330, the base station 301 and the user equipment 302 may perform downlink and uplink communication on the basis of the CSI reported by the user equipment 302. The downlink communication may be a procedure in which the base station 301 transmits downlink control information through a physical downlink control channel (PDCCH) and downlink data through a physical downlink shared channel (PDSCH) to the user equipment 302. In addition, the uplink communication may be a procedure in which the user equipment 302 transmits uplink control information through the PUCCH and uplink data through a physical uplink shared channel (PUSCH) to the base station 301. In this case, the PUCCH may include the channel status report information of the user equipment as described above.

While performing communication between the base station 301 and the user equipment 302 in operation S330, the user equipment 302 may continuously calculate an average RSRP measurement value of the reference signal on the basis of the reference signal included in the PDSCH.

In operation S332, the user equipment 302 may determine whether the average RSRP measurement value of the reference signal is greater than a (pre-)configured threshold value. When it is determined that the average RSRP measurement value of the reference signal is greater than the (pre-)configured threshold value, the user equipment 302 may continue to perform the communication in operation S330. On the other hand, when it is determined that the average RSRP measurement value of the reference signal is less than or equal to the (pre)configured threshold value, the user equipment 302 may proceed to operation S334.

In operation S334, the user equipment 302 may transmit a beam recovery request signal to the base station 301. Here, the beam recovery request signal may be a RACH preamble. Accordingly, in operation S334, the base station 301 may receive the beam recovery request signal from the user equipment 302. In this way, the case in which the user equipment 302 transmits the beam recovery request signal while performing the communication may correspond to the case in which it is determined that a beam failure/error (radio beam failure) occurs in the user equipment. Therefore, as described above, the RACH preamble transmitted by the user equipment 302 may include information on a group of candidate beams. However, each candidate beam may not necessarily have a mapping relationship with a unique preamble. When the base station 301 receives a preamble, the base station 301 may identify the group of candidate beams.

In operation S336, the base station 301 may receive a specific RACH preamble and then transmit a response to the user equipment 302. As described above, since the user equipment 302 has previously transmitted the RACH preamble to the base station 301 in operation S334, the base station 301 may transmit the RAR.

Meanwhile, in the procedure of FIG. 3 described above, there may be cases in which a mapping relationship between a preamble and a new beam being replaced to overcome the error beam cannot be one-to-one mapping. This is because the number of beam recovery request RA preambles may be smaller than the number of new candidate beams. According to 3GPP standards, this is because the number of RA preambles is limited.

According to 3GPP standards, RA preambles are defined to be classified and used as follows. In other words, cases in which random access is required may correspond to the following cases:
(1) A case in which user equipment with RRC_IDLE initially accesses (initial access from RRC_IDLE);
(2) A case of a radio resource control (RRC) connection re-establishment procedure;
(3) A case of a handover;
(4) A case in which the user equipment resets synchronization in an RRC_CONNECTED state (RRC_CONNECTED when UL synchronization status is “non-synchronized”);
(5) A case in which the user equipment transitions from RRC_INACTIVE to RRC_connection;
(6) A case in which time alignment is established at SCell addition; and
(7) A case in which the user equipment requests system information (request for other system information).

The base station should allocate a preamble to each piece of user equipment in order to rapidly process an RA preamble used for beam recovery of the user equipment. However, from a system perspective, when a plurality of preambles are allocated for beam recovery, the number of RA preambles not allocated for beam recovery may be insufficient. Therefore, there may be cases in which a mapping relationship between a preamble and a new beam being replaced to overcome the error beam cannot be one-to-one mapping.

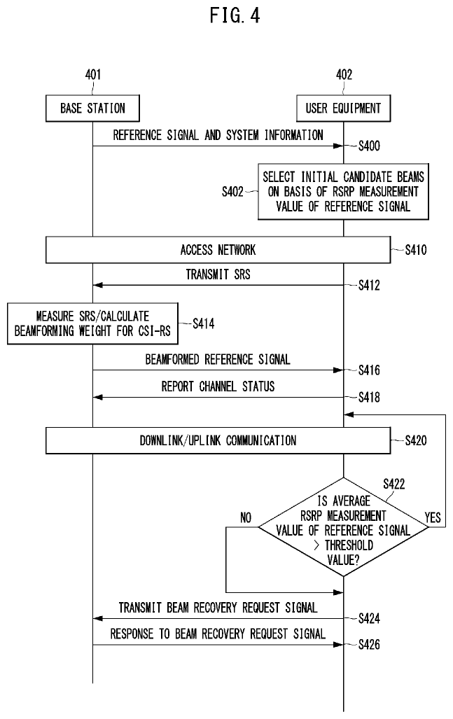

FIG. 4 is a flowchart of a case in which recovery is performed when a beam error occurs during communication after beam setting on the basis of a sounding reference signal.

In FIG. 4, a base station 401 and user equipment 402 are illustrated as components of a network. Each of the base station 401 and the user equipment 402 may include all or part of the components of the communication node 200 as illustrated in FIG. 2 above. Further, the base station 401 may further include a component for connecting to a higher level node not illustrated in FIG. 2, such as a node of a core network, a component for connecting between base stations, and the like. Further, the user equipment 402 may further include a component for a user interface, various types of sensors, and the like.

Referring to FIG. 4, the base station 401 may periodically broadcast an SSB and an SIB within its cell in operation S400, and accordingly, the user equipment 402 may obtain the SSB and the SIB in operation S400. In this case, when the base station 401 broadcasts SSBs within its cell using a plurality of beams, the base station 401 may transmit the plurality of SSBs sequentially in a downlink beam direction.

In operation S402, the user equipment 402 may measure RSRP for the reference signal included in the SSB to select initial candidate beams.

In operation S410, the user equipment 402 may transmit an RA preamble corresponding to a beam with the best RSRP for the reference signal included in the SSB to the base station 401. In operation S410, the base station 401 may transmit an RAR in response to one index among the candidate beam indexes included in the RA preamble from the RACH transmitted by the user equipment 402. In this case, the base station 401 may allocate a sounding reference signal (SRS) to the user equipment 402.

In operation S412, the user equipment 402 may transmit the SRS through the uplink through the SRS resource allocated by the base station 401 in operation S410. Therefore, the base station 401 may receive the SRS from the user equipment 402 in operation S412.

In operation S414, the base station 401 may measure the RSRP for the SRS received from the user equipment 402 and calculate a beamforming weight for the CSI-RS to be transmitted to the user equipment 402 on the basis of the measured RSRP.

In operation S416, the base station 401 may transmit a beamformed reference signal, for example, a beamformed CSI-RS, to the user equipment 402 on the basis of the beamforming weight. Accordingly, the user equipment 402 may receive the beamformed CSI-RS.

In operation S418, the user equipment 402 may measure the received CSI-RS and transmit CSI to the base station 401. Therefore, the base station 401 may obtain the CSI for the CSI-RS that is transmitted by being beamformed, from the user equipment 402.

In operation S420, the base station 401 and the user equipment 402 may perform downlink and uplink communication on the basis of the CSI reported by the user equipment 402. The downlink communication may be a procedure in which the base station 401 transmits downlink control information through a PDCCH and downlink data through a PDSCH to the user equipment 402. In addition, the uplink communication may be a procedure in which the user equipment 402 transmits uplink control information through PUCCH and uplink data through a PUSCH to the base station 401. In this case, the user equipment 402 may transmit the SRS to the base station 401 as described above.

While performing communication between the base station 401 and the user equipment 402 in operation S420, the user equipment 402 may continuously calculate an average RSRP measurement value of the reference signal on the basis of the reference signal included in the PDSCH.

In operation S422, the user equipment 402 may determine whether the average RSRP measurement value of the reference signal is greater than a (pre-)configured threshold value. When it is determined that the average RSRP measurement value of the reference signal is greater than the (pre-)configured threshold value, the user equipment 402 may continue to perform the communication in operation S420. On the other hand, when it is determined that the average RSRP measurement value of the reference signal is less than or equal to the (pre)configured threshold value, the user equipment 402 may proceed to operation S424.

In operation S424, the user equipment 402 may transmit a beam recovery request signal to the base station 401. Here, the beam recovery request signal may be a RACH preamble. Accordingly, in operation S424, the base station 401 may receive the beam recovery request signal from the user equipment 402. In this way, the case in which the user equipment 402 transmits the beam recovery request signal while performing the communication may correspond to the case in which it is determined that a beam failure/error (radio beam failure) occurs in the user equipment. Therefore, as described above, the RACH preamble transmitted by the user equipment 402 may include information on a group of candidate beams. However, each candidate beam may not necessarily have a mapping relationship with a unique preamble. When the base station 401 receives a preamble, the base station 401 may identify the group of candidate beams.

In operation S426, the base station 401 may receive a specific RACH preamble and then transmit a response to the user equipment 402. As described above, since the user equipment 402 has previously transmitted the RACH preamble to the base station 401 in operation S424, the base station 401 may transmit the RAR.

It can be seen that the operation of FIG. 4 also has the same problem as described in FIG. 3 above. In other words, the base station should allocate a preamble for each piece of user equipment in order to rapidly process an RA preamble used for beam recovery of the user equipment, but when a plurality of preambles are allocated for beam recovery, there is a problem in that the number of RA preambles not allocated for beam recovery may be insufficient.

Further, the 3GPP base station 401 described in FIG. 4 should allocate the SRS resource to the user equipment 402 in order to obtain the radio CSI of the user equipment 402, and the user equipment 402 to which the SRS resource is allocated should transmit the SRS to the base station. In this case, the base station 401 may allocate the SRS resource to the user equipment 402 periodically, dynamically, or semi-persistently. When the base station 401 dynamically allocates the SRS resource, the base station 401 may instruct the user equipment 402 to transmit the SRS resource through the PDCCH.

In ultra-reliable low latency communications (URLLC) of 3GPP Rel-16, the requirements are a block error rate (BER) of 10⁻⁶ and a latency of 0.5 to 1 millisecond (ms) for a data size of 32 bytes. In order to support services that are sensitive to time delay, such as URLLC services in high-frequency communication, a method of overcoming a beam error that is faster than the methods of overcoming the beam error described in FIGS. 3 and 4 is required.

Therefore, in the present disclosure described below, a method and apparatus in which a system with a high probability of beam errors/failures occurring between user equipment and a base station rapidly performs beam error/failure overcoming in high-frequency communication such as millimeter waves (mmWave) and THz will be described.

In the present disclosure described below, in order to rapidly overcome the beam errors between the user equipment and the base station, a method different from the conventional method in which user equipment transmits an RA preamble to a base station and a beam error recovery procedure is started based on an RA response procedure of the base station is used. As an example, in the present disclosure, a beam error recovery procedure is initiated from user equipment to a base station through a PUCCH, and methods for overcoming beam errors between the base station and the user equipment will be described.

First, in the present disclosure, the PUCCH may be divided into two purposes and two types of PUCCHs may be used. A first PUCCH may be a “UE-specific PUCCH” through which the base station allocates individually to each piece of user equipment. In addition, a second PUCCH may be a “UE-common PUCCH” that can be shared and used by all pieces of user equipment within a specific base station. In this case, the user equipment shared PUCCH may be allocated to each of a plurality of user equipment groups in consideration of the number of pieces of user equipment, the activity level of the user equipment, and the coverage of the base station. For example, when the coverage of the base station is narrow and a large number of pieces of user equipment are present within a specific base station, beam errors are likely to occur more frequently than at other base stations. Therefore, in this case, two or more UE-shared PUCCH resources may be allocated, and the pieces of user equipment that will use them among the two or more allocated UE-shared PUCCHs may be classified by group. As another example, two or more user equipment shared PUCCH resources may be allocated, and when the user equipment selects one of the two or more user equipment shared PUCCH resources, the user equipment shared PUCCH resource may be arbitrarily selected based on a pre-configured rule.

As the user equipment-specific PUCCH is allocated to each individual user equipment or the more user equipment shared PUCCH resource is allocated thereto, the beam error recovery may be performed rapidly. However, the amount of resources that the base station can allocate to the user equipment has a limitation. Therefore, in the present disclosure, a method of allocating user equipment shared PUCCH resources through a channel shared by a plurality of pieces of user equipment is proposed.

In this case, collisions may occur when the pieces of user equipment transmit simultaneously through the user equipment shared PUCCH shared by the plurality of pieces of user equipment. Such collisions may equally occur even when having two or more user equipment shared PUCCHs. Therefore, in the present disclosure, when the user equipment that has started to overcome beam errors with the user equipment shared PUCCH shared by the plurality of pieces of user equipment does not receive a response from the base station, the user equipment may re-transmit the beam recovery request to start the beam recovery procedure through the user equipment-specific PUCCH that is allocated to the corresponding user equipment by the base station.

### First Embodiment

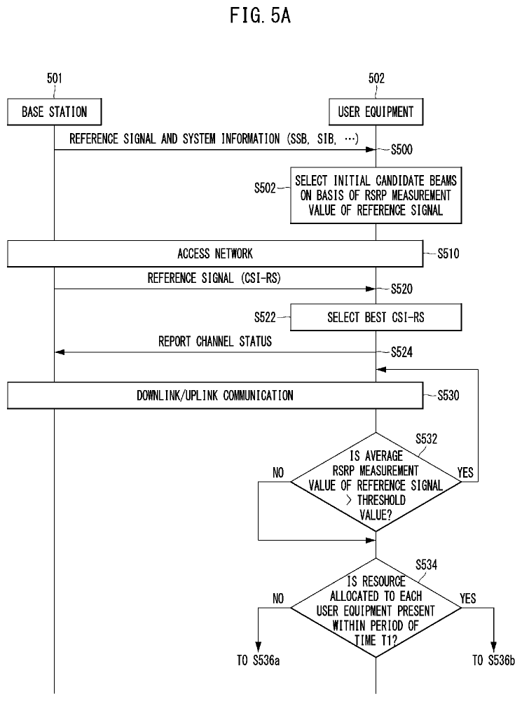

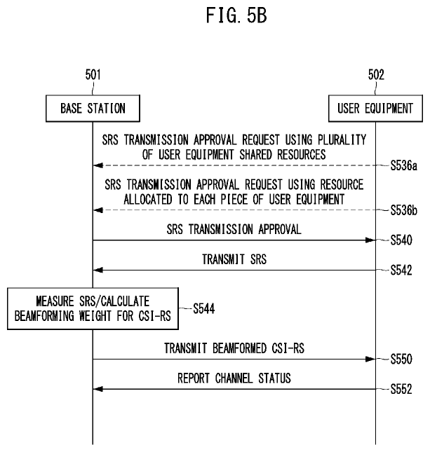

FIG. 5A is a partial flowchart for describing a first embodiment of initiating a beam management procedure based on an average RSRP measurement value of a reference signal, and FIG. 5B is a remaining flowchart for describing the first embodiment of initiating the beam management procedure based on the average RSRP measurement value of the reference signal.

FIGS. 5A and 5B are sequential flowcharts, and the operation of FIG. 5B may be performed after the operation of FIG. 5A is completed. A part of the flowchart of FIG. 5A and a part of the flowchart of FIG. 5B may be omitted or the order thereof may be changed according to an applied system or operation method. The flowcharts of FIGS. 5A and 5B illustrate an example for describing the first embodiment of the present disclosure, and the present disclosure is not limited to the example of FIGS. 5A and 5B.

As described above, in FIGS. 5A and 5B, a base station 501 and user equipment 502 are illustrated as components of a network in the same way as in FIGS. 3 and 4. Each of the base station 501 and the user equipment 502 may include all or part of the components of the communication node 200 as illustrated in FIG. 2 above. Further, the base station 501 may further include a component for connecting to a higher level node not illustrated in FIG. 2, such as a node of a core network, a component for connecting between base stations, and the like. Further, the user equipment 502 may further include a component for a user interface, various types of sensors, and the like.

Referring to FIG. 5A, the base station 501 may periodically broadcast a SSB and a SIB within its cell in operation S500, and accordingly, the user equipment 502 may obtain the SSB and the SIB in operation S500. In this case, when the base station 501 broadcasts SSBs within its cell using a plurality of beams, the base station 501 may transmit the plurality of SSBs sequentially in a downlink beam direction.

In operation S502, the user equipment 502 may measure RSRP for the reference signal included in the SSB to select initial candidate beams.

In operation S510, the user equipment 502 may transmit an RA preamble corresponding to the beam with the best RSRP for the reference signal included in the SSB to the base station 501. In operation S510, the base station 501 may transmit an RAR in response to one index among the candidate beam indexes included in the RA preamble from a RACH transmitted by the user equipment 502. In other words, operation S510 may correspond to a RACH procedure.

In operation S520, the base station 501 may transmit the reference signal, for example, the CSI-RS, to the user equipment 502. In this case, the base station 501 may transmit the CSI-RS for each beam. Therefore, in operation S520, the user equipment 502 may receive the CSI-RS for each beam and measure the CSI-RS received for each beam.

In operation S522, the user equipment 502 may select the best CSI-RS on the basis of the RSRP for the CSI-RS. In other words, the user equipment 502 may select the beam corresponding to the direction in which the RSRP value of the CSI-RS is largest in the downlink reference signal.

In operation S524, the user equipment 502 may report the CSI through a PUCCH on the basis of the selected beam. In this case, the channel status report may include CRI/CQI or CRI/PMI/RI/CQI. Further, the PUCCH may be a user equipment-specific PUCCH set for piece of user equipment. Accordingly, the base station 501 may check the beam selected by the user equipment 502 through the CSI reported by the user equipment 502 through the user equipment-specific PUCCH.

In operation S530, the base station 501 and the user equipment 502 may perform downlink and uplink communication on the basis of the CSI reported by the user equipment 502. The downlink communication may be a procedure in which the base station 501 transmits downlink control information through a PDCCH and downlink data through a PDSCH to the user equipment 502. In addition, the uplink communication may be a procedure in which the user equipment 502 transmits uplink control information through a PUCCH and uplink data through a PUSCH to the base station 501. Here, the PUCCH(s) used by the user equipment 502 during the uplink communication may be user equipment-specific PUCCHs.

Further, the user equipment 502 may measure the RSRP for the reference signal received through the downlink while performing downlink communication in operation S530, and calculate an average value of the RSRP measured during a predetermined period of time.

In operation S532, the user equipment 502 may compare the calculated average value of the RSRP with a (pre-)configured threshold value. As a result of the comparison in operation S532, when the calculated average value of the RSRP is greater than the (pre-)configured threshold value, the user equipment 502 may continue to perform the communication in operation S530. When the calculated average value of the RSRP is greater than the (pre)configured threshold value, the beam is not in an error state, and thus the downlink communication and the uplink communication may be continuously maintained.

On the other hand, when the calculated average value of the RSRP is less than or equal to the (pre)configured threshold value, the user equipment 502 may determine an SRS transmission approval request, and the user equipment 502 may proceed to operation S534.

Operation S532 may be an example of detecting a beam error. As another example of detecting a beam error, when data received from the base station 501 is decoded, an error may occur continuously more than a predetermined number of times. When the decoding error in the received data is used, it may be configured to determine whether a decoding error is detected continuously to be more than or equal to a predetermined number of times.

As still another example of detecting a beam error, the user equipment 502 may detect or predict a beam error on the basis of mobility. For example, the user equipment 502 may detect or predict mobility. More specifically, when the user equipment 502 moves, the user equipment 502 may manage the history of changes in the RSRP value of the reference signal received from the base station 501. When the measured RSRP continues to decrease, it may be determined that the user equipment 502 is moving. Therefore, in this case, new beam setting may be requested in advance before the beam error occurs.

As still another example, the user equipment 502 may measure the RSRP for beams other than the beam currently used for communication while communicating with the base station 501 in operation S530. When the user equipment 502 can measure the RSRP for beams other than the beam currently used for communication with the base station 501, the user equipment 502 may compare the RSRP for the reference signal received through the beam used for communication with the RSRP for the reference signal of another beam. Based on a result of the comparison, the user equipment 502 may request a beam change in advance.

As described above, operation S532 is an example and uses the average RSRP measurement value of the reference signal, and may be understood as a procedure for detecting the occurrence of a beam error. Further, as described above, it is possible to predict the occurrence of beam errors in advance.

In operation S534, the user equipment 502 may determine whether a PUCCH allocated to the user equipment 502 is present within a first period of time T1 that is (pre-)configured in the system (e.g., a base station). Here, the PUCCH allocated to the user equipment 502 may be the user equipment-specific PUCCH described above. Further, the pre-configured first period of time in the system may be a maximum time value set for transmitting the SRS transmission approval request to the base station 501. The first period of time may be pre-configured by higher layer signaling. As a result of the determination in operation S534, when the user equipment-specific PUCCH is present within the pre-configured first period of time in the system, the user equipment 502 may proceed to operation S536b, or when the user equipment-specific PUCCH is not present within the pre-configured first period of time in the system, the user equipment 502 may proceed to operation S536a.

The subsequent operation will be described with reference to FIG. 5B.

Referring to FIG. 5B, operations S536a and S536b are both indicated with dotted lines. Operations S536a and S536b are indicated with dotted lines to identify that when one of the two operations is performed, the other is not performed. In other words, the user equipment 502 does not perform operation S536b when performing operation S536a, and does not perform operation S536a when performing operation S536b.

When the user equipment 502 proceeds to operation S536a because there is no user equipment-specific PUCCH within the pre-configured first period of time T1 in the system, the user equipment 502 may transmit the SRS transmission approval request to the base station 501 using a plurality of user equipment shared resources. In this case, the plurality of pieces of user equipment shared resources may be a user equipment shared PUCCH described above. Here, the user equipment shared PUCCH may be pre-configured by the base station 501 to the pieces of user equipment in the base station 501, as described in FIG. 5B above. As a method of preconfiguring the user equipment shared PUCCH, the SIB may be modified, a newly defined SIB may be used, or the user equipment shared PUCCH may be preconfigured to the pieces of user equipment through higher layer signaling.

When the user equipment 502 transmits the SRS transmission approval request through the user equipment shared PUCCH, the user equipment 502 may transmit the SRS transmission approval request by adding a user equipment identifier thereto. Therefore, the base station 501 may check which user equipment transmitted the SRS transmission approval request by obtaining the user equipment identifier included in the SRS transmission approval request.

When the user equipment 502 proceeds to operation S536b because the user equipment-specific PUCCH is present within the pre-configured first period of time T1 in the system, the user equipment 502 may transmit the SRS transmission approval request to the base station 501 using the resources allocated to each piece of user equipment.

When the user equipment 502 transmits the PUCCH to the base station 501 in operation S536a or S536b, the beam direction may be selected from the beam directions of the downlink reference signal measured by the user equipment 502, which is the user equipment's most preferred direction. In other words, the beam direction of the PUCCH that is transmitted from the user equipment 502 to the base station 501 may be selected to correspond to the beam transmitting the reference signal with the largest RSRP among the downlink reference signals received from the base station 501. Therefore, the base station 501 may receive the SRS transmission approval request transmitted by the user equipment 502 in operation S536a or S536b.

In the above case, assuming that the user equipment 502 transmits the SRS transmission approval request through the user equipment shared PUCCH in operation S536a. In this case, from the base station 501's perspective, one or more user equipment shared PUCCHs may be received. The base station 501 may receive the user equipment shared PUCCH by beam sweeping with a plurality of antennas in order to receive the user equipment shared PUCCHs received from different directions. In this case, when the base station 501 receives the user equipment shared PUCCH using a specific beam, it is possible to check which user equipment transmitted the user equipment shared PUCCH using the user equipment identifier included in the user equipment shared PUCCH.

Although not illustrated in FIG. 5B, the user equipment 502 may set a timer for retransmission of the SRS transmission approval request after performing operation S536a. When the SRS transmission approval is received in operation S540 before the timer for retransmission of the SRS transmission approval request expires, the user equipment 502 may stop the timer for retransmission of the SRS transmission approval request. On the other hand, when the SRS transmission approval is not received until the timer for retransmission of the SRS transmission approval request expires, the user equipment 502 may re-transmit the SRS transmission approval request.

When the timer for retransmission of the SRS transmission approval request expires, the user equipment 502 may re-transmit the SRS transmission approval request through the user equipment-specific PUCCH. In the present disclosure, it is assumed that the user equipment-specific PUCCH is used when the SRS transmission approval request is re-transmitted. However, the present disclosure is not limited thereto. In other words, when the SRS transmission approval request is re-transmitted, the SRS transmission approval request may be re-transmitted through the user equipment shared PUCCH.

In other words, even during retransmission, it is determined again whether the user equipment-specific PUCCH is present within the pre-configured first period of time T1, and when it is determined that the user equipment-specific PUCCH is not present within the pre-configured first period of time, the SRS transmission approval request may be re-transmitted through the user equipment shared PUCCH.

Referring to FIG. 5B again, the base station 501 may transmit an SRS transmission approval to the user equipment 502 in operation S540. Accordingly, the user equipment 502 may receive the SRS transmission approval from the base station 501 in operation S540, and obtain resource information for transmitting the SRS through higher layer signaling provided in advanced from the base station 501. In this case, the case in which the base station 501 transmits the SRS transmission approval to the user equipment 502 is the case in which the SRS transmission approval request is received through the user equipment shared PUCCH or the case in which the SRS transmission approval request is received through the user equipment-specific PUCCH, and the base station 501 may not need to determine whether the user equipment shared PUCCH or user equipment-specific PUCCH received from the user equipment 502 is an initial transmission or a retransmission.

In operation S542, the user equipment 502 may transmit an SRS to the base station 501 through the resource allocated by the base station 501 for SRS transmission in operation S540. Therefore, the base station 501 may receive the SRS from the user equipment 502 in operation S542.

In operation S544, the base station 501 may measure RSRP for the SRS received from the user equipment 502 and calculate a beamforming weight for the CSI-RS to be transmitted to the user equipment 502 on the basis of the measured RSRP.

In operation S550, the base station 501 may transmit a beamformed reference signal, for example, a beamformed CSI-RS, to the user equipment 502 on the basis of the beamforming weight. Accordingly, the user equipment 502 may receive the beamformed CSI-RS.

In operation S552, the user equipment 502 may measure the received CSI-RS and generate CSI. In addition, the user equipment 502 may transmit a channel status report to the base station 501. In this case, the channel status report may include CRI/CQI or CRI/PMI/RI/CQI.

As illustrated in FIGS. 5A and 5B, according to the present disclosure, when the user equipment identifies the beam error, the user equipment may request immediately starting of a beam error recovery procedure from the base station using the PUCCH. In other words, compared to the existing method using the RA preamble, the user equipment may request starting of the beam error recovery procedure from the base station. Further, since the user equipment shared PUCCH may be used even when the user equipment-specific PUCCH is not allocated to the user equipment, a delay in starting the beam error recovery procedure may be prevented.

### Second Embodiment

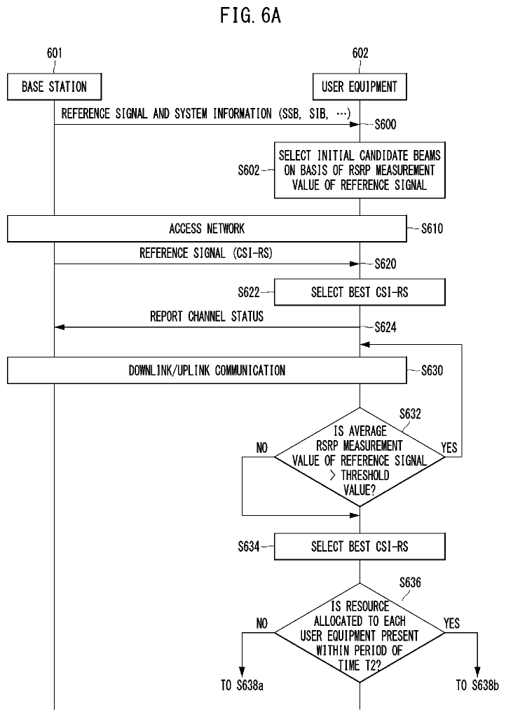

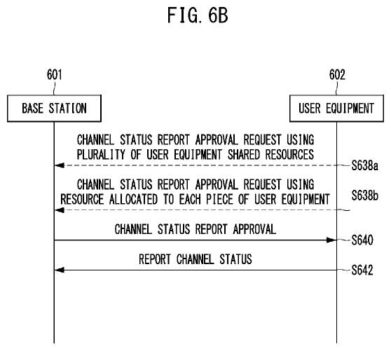

FIG. 6A is a partial flowchart for describing a second embodiment of initiating a beam management procedure based on an average RSRP measurement value of a reference signal, and FIG. 6B is a remaining flowchart for describing the second embodiment of initiating the beam management procedure based on the average RSRP measurement value of the reference signal.

FIGS. 6A and 6B are sequential flowcharts, and the operation of FIG. 6B may be performed after the operation of FIG. 6A is completed. A part of the flowchart of FIG. 6A and a part of the flowchart of FIG. 6B may be omitted or the order thereof may be changed according to the applied system or operation method. The flowcharts of FIGS. 6A and 6B illustrate an example for describing the second embodiment of the present disclosure, and the present disclosure is not limited to the example of FIGS. 6A and 6B.

As described above, in FIGS. 6A and 6B, a base station 601 and user equipment 602 are illustrated as components of a network. Each of the base station 601 and the user equipment 602 may include all or part of the components of the communication node 200 as illustrated in FIG. 2 above. Further, the base station 601 may further include a component for connecting to a higher level node not illustrated in FIG. 2, such as a node of a core network, a component for connecting between base stations, and the like. Further, the user equipment 602 may further include a component for a user interface, various types of sensors, and the like.

Referring to FIG. 6A, the base station 601 may periodically broadcast an SSB and an SIB within its cell in operation S600, and accordingly, the user equipment 602 may obtain the SSB and the SIB in operation S600. In this case, when the base station 601 broadcasts SSBs within its cell using a plurality of beams, the base station 601 may transmit the plurality of SSBs sequentially in a downlink beam direction.

In operation S602, the user equipment 602 may measure RSRP for the reference signal included in the SSB to select initial candidate beams.

In operation S610, the user equipment 602 may transmit an RA preamble corresponding to the beam with the best RSRP for the reference signal included in the SSB to the base station 601. In operation S610, the base station 601 may transmit an RAR in response to one index among the candidate beam indexes included in the RA preamble from a RACH transmitted by the user equipment 602. In other words, operation S610 may correspond to a RACH procedure.

In operation S620, the base station 601 may transmit the reference signal, for example, the CSI-RS, to the user equipment 602. In this case, the base station 601 may transmit the CSI-RS for each beam. Therefore, in operation S620, the user equipment 602 may receive the CSI-RS for each beam and measure the CSI-RS received for each beam.

In operation S622, the user equipment 602 may select the best CSI-RS on the basis of the RSRP for the CSI-RS. In other words, the user equipment 602 may select the beam corresponding to the direction in which the RSRP value of the CSI-RS is largest in the downlink reference signal.

In operation S624, the user equipment 602 may report the CSI through the PUCCH on the basis of the selected beam. In this case, the channel status report may include CRI/CQI or CRI/PMI/RI/CQI. Further, the PUCCH may be a user equipment-specific PUCCH set for piece of user equipment. Accordingly, the base station 601 may check the beam selected by the user equipment 602 through the CSI reported by the user equipment 602 through the user equipment-specific PUCCH.

In operation S630, the base station 601 and the user equipment 602 may perform downlink and uplink communication on the basis of the CSI reported by the user equipment 602. The downlink communication may be a procedure in which the base station 601 transmits downlink control information through a PDCCH and downlink data through a PDSCH to the user equipment 602. In addition, the uplink communication may be a procedure in which the user equipment 602 transmits uplink control information through a PUCCH and uplink data through a PUSCH to the base station 601. Here, the PUCCH(s) used by the user equipment 602 during the uplink communication may be user equipment-specific PUCCHs.

Further, the user equipment 602 may measure the RSRP for the reference signal received through the downlink while performing downlink communication in operation S630, and calculate the average value of the RSRP measured during a predetermined period of time.

In operation S632, the user equipment 602 may compare the calculated average value of the RSRP with a (pre)configured threshold value. As a result of the comparison in operation S632, when the calculated average value of the RSRP is greater than the (pre)configured threshold value, the user equipment 602 may continue to perform the communication in operation S630. When the calculated average value of the RSRP is greater than the (pre)configured threshold value, the beam is not in an error state, and thus the downlink communication and the uplink communication may be continuously maintained.

On the other hand, when the calculated average value of the RSRP is less than or equal to the (pre)configured threshold value, the user equipment 602 may determine an SRS transmission approval request, and the user equipment 602 may proceed to operation S634.

Operation S632 of FIG. 6A may also become an example of detecting a beam error as described above in operation S532 of FIG. 5A. Therefore, it can be understood as one of the various methods described in FIG. 5A or implemented as an alternative thereto. In other words, operation S632 is an example and uses the average RSRP measurement value of the reference signal, and may be understood as a procedure for detecting the occurrence of a beam error.

In operation S634, the user equipment 602 may select the best CSI-RS. In this case, the best CSI-RS may be a CSI-RS with the largest RSRP for the most recently measured CSI-RS among the CSI-RSs received from the base station 601 in operation S630. As another example, the best CSI-RS may be selected based on a cumulative value of RSRP measured for CSI-RS for a predetermined number of times, including the most recently measured CSI-RS. There may be various methods for selecting the best CSI-RS, and the present disclosure does not have any special limitations on the method for selecting the best CSI-RS. Here, the best CSI-RS may be a procedure for specifying the beam that transmitted the best CSI-RS.

In operation S636, the user equipment 602 may determine whether a PUCCH allocated to the user equipment 602 is present within a second period of time T2 that is (pre)configured in the system (e.g., a base station). Here, the PUCCH allocated to the user equipment 602 may be the user equipment-specific PUCCH described above. Further, the preconfigured second period of time in the system may be a maximum time value set for transmitting the channel status report approval request to the base station 601. As a result of the determination in operation S636, when the user equipment-specific PUCCH is present within the pre-configured second period of time in the system, the user equipment 602 may proceed to operation S638b, or when the user equipment-specific PUCCH is not present within the pre-configured second period of time in the system, the user equipment 602 may proceed to operation S638a.

Meanwhile, the pre-configured first period of time T1 has been described in FIGS. 5A and 5B. The first period of time T1 is a maximum time value set for transmitting the SRS transmission approval request to the base station 601, and the second period of time T2 is a maximum time value set for transmitting the channel status report approval request to the base station 601. When the first period of time and the second period of time are set to the same period of time by the system, the two values may be the same time value. When the first period of time and the second period of time are set differently by the system, the two values may be different time values. The second period of time may also be pre-configured by higher layer signaling. It should be noted that in the present disclosure, the description is made as the first period of time T1 and the second period of time T2 to identify the two values, regardless of whether the two values are the same.

The subsequent operation will be described with reference to FIG. 6B.

Referring to FIG. 6B, operations S638a and S638b are both indicated with dotted lines. Operations S638a and S638b are indicated with dotted lines to identify that when one of the two operations is performed, the other is not performed. In other words, the user equipment 602 does not perform operation S638b when performing operation S638a, and does not perform operation S638a when performing operation S638b.

When the user equipment 602 proceeds to operation S638a because there is no user equipment-specific PUCCH within the pre-configured second period of time T2 in the system, the user equipment 602 may transmit the channel status report approval request to the base station 601 using a plurality of pieces of user equipment shared resources. In this case, the plurality of pieces of user equipment shared resources may be the user equipment shared PUCCH described above. Here, the user equipment shared PUCCH may be preconfigured by the base station 601 to the pieces of user equipment in the base station 601, as described in FIG. 6B above. As a method to pre-configure the user equipment shared PUCCH, the SIB may be modified, a newly defined SIB may be used, or the user equipment shared PUCCH may be preset to the pieces of user equipment through higher layer signaling.

Further, when the user equipment 602 transmits the channel status report approval request through the user equipment shared PUCCH, the user equipment 602 may transmit the channel status report approval request by adding a user equipment identifier thereto. Therefore, the base station 601 may check which user equipment transmitted the channel status report approval request by obtaining the user equipment identifier included in the channel status report approval request.

When the user equipment 602 proceeds to operation S638b because the user equipment-specific PUCCH is present within the pre-configured second period of time T2 in the system, the user equipment 602 may transmit the channel status report approval request to the base station 601 using the resources allocated to each piece of user equipment.

When the user equipment 602 transmits the PUCCH to the base station 601 in operation S638a or S638b, the beam direction may be selected from the beam directions of the downlink reference signal measured by the user equipment 602, which is the user equipment's most preferred direction. In other words, the beam direction of the PUCCH that is transmitted from the user equipment 602 to the base station 601 may be selected to correspond to the beam transmitting the reference signal with the largest RSRP among the downlink reference signals received from the base station 601. Therefore, the base station 601 may receive the channel status report approval request transmitted by the user equipment 602 in operation S638a or S638b.

In the above case, assuming that the user equipment 602 transmits the channel status report approval request through the user equipment shared PUCCH in operation S638a. In this case, from the base station 601's perspective, one or more user equipment shared PUCCHs may be received. The base station 601 may receive the user equipment shared PUCCH by beam sweeping with a plurality of antennas in order to receive the user equipment shared PUCCHs received from different directions. In this case, when the base station 601 receives the user equipment shared PUCCH using a specific beam, it is possible to check which user equipment transmitted the user equipment shared PUCCH using the user equipment identifier included in the user equipment shared PUCCH.

Although not illustrated in FIG. 6B, the user equipment 602 may set a timer for retransmission of the channel status report approval request after performing operation S638a. When the channel status report approval is received in operation S640 before the timer for retransmission of the channel status report approval request expires, the user equipment 602 may stop the timer for retransmission of the channel status report approval request. On the other hand, when the channel status report approval is not received until the timer for retransmission of the channel status report approval request expires, the user equipment 602 may re-transmit the channel status report approval request. In this case, when re-transmitting the channel status report approval request, the user equipment 602 may re-transmit the channel status report approval request through the user equipment-specific PUCCH. In the present disclosure, it is assumed that the user equipment-specific PUCCH is used when the channel status report approval request is re-transmitted. However, the present disclosure is not limited thereto. In other words, when the channel status report approval request is re-transmitted, the channel status report the transmission approval request may be re-transmitted through the user equipment shared PUCCH.

Referring to FIG. 6B again, the base station 601 may transmit a channel status report approval to the user equipment 602 in operation S640. The channel status report approval may include resource information through which the user equipment 602 will transmit the channel status report. Accordingly, the user equipment 602 may receive the channel status report approval from the base station 601 in operation S640 and obtain resource information for transmitting the channel status report. In this case, the case in which the base station 601 transmits the channel status report approval to the user equipment 602 is the case in which the channel status report approval request is received through the user equipment shared PUCCH or the case in which the channel status report approval request is received through the user equipment-specific PUCCH, and the base station 601 may not need to determine whether the user equipment shared PUCCH or user equipment-specific PUCCH received from the user equipment 602 is an initial transmission or a retransmission.

In operation S642, the user equipment 602 may transmit a channel status report to the base station 601 through the allocated resource included in the channel status report approval of the base station 601 in operation S640. In this case, the channel status report may include information on the beam that transmitted the best CSI-RS selected in operation S634. Therefore, the base station 601 may receive the channel status report from the user equipment 602 in operation S642. In addition, the beam information included in the channel status report may be identified. In this case, the channel status report may include CRI/CQI or CRI/PMI/RI/CQI for the beam selected in operation S634.

As illustrated in FIGS. 6A and 6B, according to the present disclosure, when the user equipment identifies the beam error, the user equipment may request immediately starting of a beam error recovery procedure from the base station using the PUCCH. In other words, compared to the existing method using the RA preamble, the user equipment may request starting of the beam error recovery procedure from the base station. Further, since the user equipment shared PUCCH may be used even when the user equipment-specific PUCCH is not allocated to the user equipment, a delay in starting the beam error recovery procedure may be prevented.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of user equipment, comprising:
determining whether an error condition for a first beam communicating with a base station is met;
when it is determined that the error condition for the first beam is met, determining whether a first physical uplink control channel (PUCCH) allocated to the user equipment is present within a predetermined first period of time;
when it is determined that the first PUCCH is not present, transmitting a sounding reference signal (SRS) transmission approval request and an identifier of the user equipment to the base station through a second PUCCH pre-configured to be shared by all pieces of user equipment; and
when an SRS transmission approval is received from the base station, transmitting an SRS to the base station.

2. The method of claim 1, further comprising:
after the SRS is transmitted to the base station, receiving a beamformed reference signal (RS) from the base station; and
transmitting a channel status report to the base station by measuring the received RS.

3. The method of claim 1, wherein a case in which the error condition for the first beam is met is:
a case in which an average value of reference signals received power (RSRP) for the RS received from the base station through the first beam is less than or equal to a pre-configured threshold value; or
a case in which a consecutive decoding error of data received from the base station through the first beam is more than or equal to a preset number of times.

4. The method of claim 1, wherein the second PUCCH is pre-configured by higher layer signaling or a system information block (SIB).

5. The method of claim 1, further comprising:
when it is determined that the first PUCCH allocated to the user equipment is present within the first period of time, transmitting the SRS transmission approval request to the base station through the first PUCCH; and
when the SRS transmission approval is received from the base station, transmitting the SRS to the base station.

6. The method of claim 1, further comprising:
when the SRS transmission approval is not received from the base station within a predetermined second period of time after transmitting the SRS transmission approval request to the base station, determining whether a third PUCCH allocated to the user equipment is present within the first period of time; and
when it is determined that the third PUCCH is present, re-transmitting the SRS transmission approval request to the base station through the third PUCCH.

7. The method of claim 6, further comprising, when the SRS transmission approval is not received within the second period of time after transmitting the SRS transmission approval request to the base station, and when the third PUCCH is not present within the first period of time, re-transmitting the SRS transmission approval request to the base station through the second PUCCH.

8. A method of user equipment, comprising:
determining whether an error condition for a first beam communicating with a base station is met;
when it is determined that the error condition for the first beam is met, selecting a reference signal (RS) with a largest reference signals received power (RSRP) value from among RSs received through beams other than the first beam;
determining whether a first physical uplink control channel (PUCCH) allocated to the user equipment is present within a predetermined first period of time;
when it is determined that the first PUCCH is not present, transmitting a channel status report approval request and an identifier of the user equipment to the base station through a pre-configured second PUCCH to be shared by all pieces of user equipment; and
when a channel status report approval is received from the base station, transmitting a channel status report for the beam on which the RS with the largest RSRP value is transmitted to the base station.

9. The method of claim 8, wherein a case in which the error condition for the first beam is met is:
a case in which an average value of the RSRP for the RS received from the base station through the first beam is less than or equal to a (pre)configured threshold value; or
a case in which a consecutive decoding error of data received from the base station through the first beam is more than or equal to a preset number of times.

10. The method of claim 8, wherein the second PUCCH is preset by higher layer signaling or a system information block (SIB).

11. The method of claim 8, further comprising:
when it is determined that the first PUCCH allocated to the user equipment is present within the first period of time, transmitting the channel status report approval request to the base station through the first PUCCH; and
when the channel status report approval is received from the base station, transmitting the channel status report to the base station.

12. The method of claim 8, further comprising:
when the channel status report approval is not received from the base station within a predetermined second period of time after transmitting the channel status report approval request to the base station, determining whether a third PUCCH allocated to the user equipment is present within the first period of time; and
when it is determined that the third PUCCH is present, re-transmitting the channel status report approval request to the base station through the third PUCCH.

13. The method of claim 12, further comprising, when the channel status report approval is not received within the second period of time after transmitting the channel status report approval request to the base station, and when the third PUCCH is not present within the first period of time, re-transmitting the channel status report approval request to the base station through the second PUCCH.

14. A method of a base station, comprising:
transmitting information on a pre-configured second physical uplink control channel (PUCCH) to user equipment to be shared by all pieces of user equipment in the base station;
determining a first beam to be used for communication with the user equipment through a random access procedure;
communicating with the user equipment through the first beam;
receiving a sounding reference signal (SRS) transmission approval request for beam recovery from the user equipment through the second PUCCH; and
transmitting an SRS transmission approval to the user equipment in response to the SRS transmission approval request.

15. The method of claim 14, further comprising:
receiving an SRS from the user equipment;
measuring the received SRS and calculating a beamforming weight of a reference signal (RS) to be transmitted to the user equipment;
transmitting a beamformed reference signal to the user equipment using the beamforming weight; and
receiving a channel status report from the user equipment.

16. The method of claim 14, wherein the information on the second PUCCH is transmitted to the user equipment through higher layer signaling or a system information block (SIB).

17. The method of claim 14, further comprising transmitting condition information including a first period of time for using the second PUCCH to the user equipment through higher layer signaling,
wherein the condition information instructs the user equipment to use the second PUCCH when a first PUCCH allocated to the user equipment is not present within the first period of time, when the error condition is met.

18. The method of claim 17, wherein a case in which the error condition is met is:
a case in which an average value of reference signals received power (RSRP) for the RS received from the base station through the first beam is less than or equal to a (pre)configured threshold value; or
a case in which a consecutive decoding error of data received from the base station through the first beam is more than or equal to a preset number of times.

19. The method of claim 14, further comprising:
when the SRS transmission approval request for the beam recovery is received through the first PUCCH allocated to the user equipment during the communication, transmitting an SRS transmission approval including SRS transmission resource allocation information to the user equipment;
receiving the SRS from the user equipment;
measuring the received SRS and calculating a beamforming weight of a RS to be transmitted to the user equipment;
transmitting a beam formed reference signal to the user equipment using the beamforming weight; and
receiving a channel status report from the user equipment.
